(19) United States
(12) Patent Application Publication
(10) Pub. No.: US 2012/0162351 A1
(43) Pub. Date: Jun. 28, 2012

(54) MULTIMEDIA, MULTIUSER SYSTEM AND ASSOCIATED METHODS

(76) Inventors: Michael R. Feldman, Huntersville, NC (US); James E. Morris, Lake Wylie, SC (US); Adam S. Fedor, Boulder, CO (US); Ron Gilson, Charlotte, NC (US)

(21) Appl. No.: 13/353,283

(22) Filed: Jan. 18, 2012

Related U.S. Application Data
(63) Continuation-in-part of application No. 12/650,684, filed on Dec. 31, 2009.
Application No. 12/650,684 is a continuation-in-part of application No. 12/588,774, filed on Oct. 27, 2009.
Application No. 12/588,774 is a continuation-in-part of application No. 12/222,670, filed on Aug. 13, 2008.
(60) Provisional application No. 60/994,458, filed on Sep. 19, 2007.
(60) Provisional application No. 61/272,591, filed on Oct. 9, 2009.
(60) Provisional application No. 61/433,681, filed on Jan. 18, 2011.
(60) Provisional application No. 61/521,081, filed on Aug. 8, 2011.

(51) Int. Cl. H04N 7/14; G06F 3/02; G06F 3/041

(52) U.S. Cl. 348/14.03; 345/173; 345/168; 348/E07.084

(57) ABSTRACT

Embodiments are directed to a system that may include a table with multiple user stations, a touch screen embedded in a top surface of the table, a table computer connected to the touch screen, and at least two mobile device connectors connected to the table computer and configured to be connected to a secondary screen viewable from the multiple user stations, wherein touching the touch screen at appropriate locations results in selection of content from a mobile device connected to the first mobile device connector, content from a mobile device connected to the second mobile device connector, and content from the table computer to be sent to at least one of the touch screen and the secondary screen for display thereon, and touching the touch screen at other appropriate locations results in another function in addition to selection of content for display.

### CROSS-REFERENCE TO RELATED APPLICATIONS

The present application claims priority under 35 U.S.C. §119(e) to U.S. Provisional Application Ser. No. 60/994,458, entitled “Multimedia Restaurant and Booth”, filed on Sep. 20, 2007, to U.S. Provisional Application Ser. No. 61/272,591, entitled “Multimedia, Multiuser System and Associated Methods”, filed Oct. 9, 2009, to U.S. Provisional Application Ser. No. 61/433,681, entitled “Multimedia, Multiuser System and Associated Methods,” filed Jan. 18, 2011, and to U.S. Provisional Application No. 61/521,081, entitled “Table and Monitor for Wireless Display of Mobile Devices,” filed Aug. 8, 2011, and is a continuation-in-part of U.S. patent application Ser. No. 12/650,684 filed on Dec. 31, 2009, entitled” Multimedia, Multiuser System and Associated Methods,” which is a continuation-in-part of U.S. patent application Ser. No. 12/588,774 filed on Oct. 27, 2009, entitled” Multimedia, Multiuser System and Associated Methods,” which is a continuation-in-part of U.S. patent application Ser. No. 12/222,670, filed on Aug. 13, 2008, entitled “Multimedia Restaurant System, Booth and Associated Methods,” which are hereby incorporated by reference in their entirety for all purposes.

### FIELD

Embodiments are directed to a display in a collaborative environment in which different users may control what is displayed on a common display from numerous different devices.

### DESCRIPTION OF THE RELATED ART

Currently, people may connect mobile devices to projectors using connectors that directly plug devices into the projector. For connecting more than one device, a switch is often used to change which signal is sent to the projector. One method used with a switch is to have mechanical buttons placed on the table to change the settings on the switch to change which mobile device is connected to each projector. Another option is the use of a disk that sits on top of the table and can be moved around. One disk is used for each mobile device to be connected. Each disk contains a hardwired connection to a switch and a button is located on top of the disk. However, the use of these disks adds clutter to the table as well as additional cost. The additional hardware and expense comes with very little increase in functionality. If additional hardware and cost is to be added to a conventional conference room table it is desirable if the hardware were to have more functionality in addition to that of just switching the devices displayed on the projector. Further, such a switch only allows content from one mobile device to be displayed on each screen at a time.

In addition, with current mobile devices, in some cases wireless connections are preferred over wired connections. Mobile devices may be connected to a projector on a same network. Such connection requiring software to be downloaded and installed on the mobile device. This software then digitizes the output of the device and sends it wirelessly to the projector. The projector then stores the digitized video signals from the mobile devices. The projector then combines these signals and displays them

However, current wireless connections have numerous disadvantages, e.g., are non-intuitive, require time for installation of software, and compatibility issues with various operating systems. Thus, wireless connections have not received as much success in the market place as the basic switch and the disk method described above for multiple user applications.

### SUMMARY

Embodiments are directed to a system that may include a table with multiple user stations, a touch screen embedded in a top surface of the table, a table computer connected to the touch screen, and at least two mobile device connectors connected to the table computer and configured to be connected to a secondary screen viewable from the multiple user stations, wherein touching the touch screen at appropriate locations results in selection of content from a mobile device connected to the first mobile device connector, content from a mobile device connected to the second mobile device connector, and content from the table computer to be sent to at least one of the touch screen and the secondary screen for display thereon, and touching the touch screen at other appropriate locations results in another function in addition to selection of content for display.

The system may include a switching box, the table computer and the at least two mobile device connectors being connected to the switching box.

The switching box may be configured to receive an output from video conferencing equipment, wherein, during operation of the video conferencing processor, the video conferencing processor receives content from a remote location.

The table computer may be configured to control the video conferencing equipment.

The system as may include a camera focused on at least one of the multiple user stations, the camera outputting an image to the video conferencing processor.

Touching the touch screen at the appropriate locations may result in selection of content from a mobile device connected to the first mobile device connector, content from a mobile device connected to the second mobile device connector, content from the table computer, content from the camera, and content from a remote location to be sent to at least one of the touch screen and the secondary screen for display thereon.

The system may include a video conferencing processor, wherein the at least two mobile device connectors and the table computer are connected to the video conferencing processor, wherein, during operation of the video conferencing processor, the video conferencing processor receives content from a remote location.

Touching the touch screen at the appropriate locations may result in selection of content from a mobile device connected to the first mobile device connector, content from a mobile device connected to the second mobile device connector, content from the table computer, and content from a remote location to be sent to at least one of the touch screen and the secondary screen for display thereon.

The system may include a camera focused on at least one of the user stations, the camera outputting an image to the video conferencing processor.

The at least one additional function may include web browsing.

The table computer, when operating, may divide the touch screen display into multiple sections and may allow simultaneous, independent web browsing in each section.

The table computer, when operating, may allow an image in a section to be published to the secondary screen.

The table computer, when operating, may connect to mobile devices wirelessly.

The table computer, when operating, may generate a code and may display the code on one of the touch screen display and the secondary screen.

The code may be a password for entry by a user into a mobile device, a spatial code to be read by the mobile device adjacent the code, and/or a time sequential code to be read by the mobile device in contact with the touch screen.

The system may include a video processor between the at least two mobile device connectors and the secondary screen, the video processor, when operating, may superimpose content from the at least two mobile device connectors.

When operation, the table computer may divide the secondary screen into a number screen sections and may simultaneously display content from the at least two mobile device connectors.

The table computer, when operating, may divide the touch screen display into multiple sections and may allow simultaneous, independent virtual keyboard entry in each section using a system keyboard.

Embodiments are directed to a system that may include a table with multiple user stations, a touch screen embedded in a top surface of the table, a table computer connected to the touch screen, and a wireless network, wherein the table computer, when operating, emulates a streaming video receiver, connects wirelessly with a mobile device, and receives content from the mobile device to be displayed on the touch screen.

Embodiments are directed to a system that may include a table with multiple user stations, a touch screen embedded in a top surface of the table, and a table computer connected to the touch screen, wherein, the table computer, when operating, divides the touch screen display into multiple sections and allows simultaneous, independent web browsing in each section.

### BRIEF DESCRIPTION OF THE DRAWINGS

FIG. 1 illustrates a top down schematic view of an embodiment;

FIG. 2 illustrates a top down schematic view of another embodiment;

FIG. 3 illustrates a block diagram of a network according to an embodiment;

FIG. 4 illustrates a block diagram of a network according to an embodiment;

FIG. 5 illustrates a block diagram of a network according to an embodiment;

FIG. 6 illustrates a flowchart for securing a wireless connection according to an embodiment;

FIGS. 7A and 7B illustrate a top schematic view of a table display providing a code to a mobile device according to embodiments;

FIG. 8 illustrates a block diagram of a network according to an embodiment;

FIG. 9 illustrates a block diagram of a network according to an embodiment;

FIGS. 10A to 10D illustrate schematic top views of different stages of use of a table display according to an embodiment;

FIG. 11 illustrates a schematic top view a table display according to an embodiment;

FIG. 12 illustrates a schematic top view a table display according to an embodiment;

FIG. 13 illustrates a top down schematic view a table display according to an embodiment; and

FIG. 14 illustrates a block diagram of a network according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

As used herein, “table display” is to refer to a monitor or television mounted horizontally and size to have at least two user stations, and “wall display” is to refer to a monitor or television mounted vertically, or at any other convenient position for viewing at the proper orientation by users at the stations of the table.

It is desirable for multiple users at a table and share information on their mobile devices. The mobile devices may be: lap top computers, smart phones or tablet computers. The information that may be shared includes photos, videos and whatever content is on the display screen of one of these mobile devices.

It is also desirable for the users at the table to be able to view the content from multiple devices on the table display and the wall display at the same time and have the ability to change which devices are displayed in real time with an easy intuitive control mechanism.

It is also desirable to do all of the above without requiring users to download software that may take a long time to download or may contain viruses.

It is further desirable to implement the above in a secure manner, so that users that are not at the table cannot push content to the wall display unless they are authorized.

It is also desirable to provide a fixed computer associated with the table, such that the table may be used even without mobile devices and instructions for using the table may be readily provided.

It is also desirable to divide the table display into multiple screens, e.g., so that users at various stations may separately and simultaneously control content displayed.

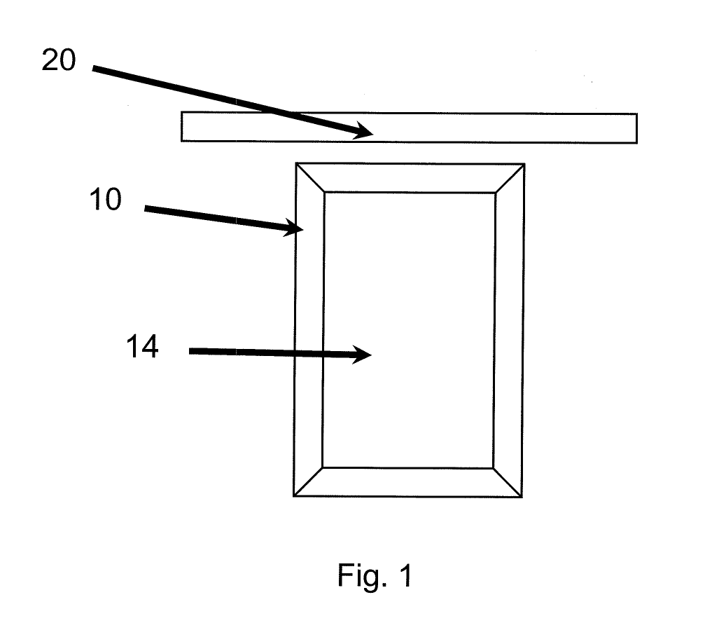

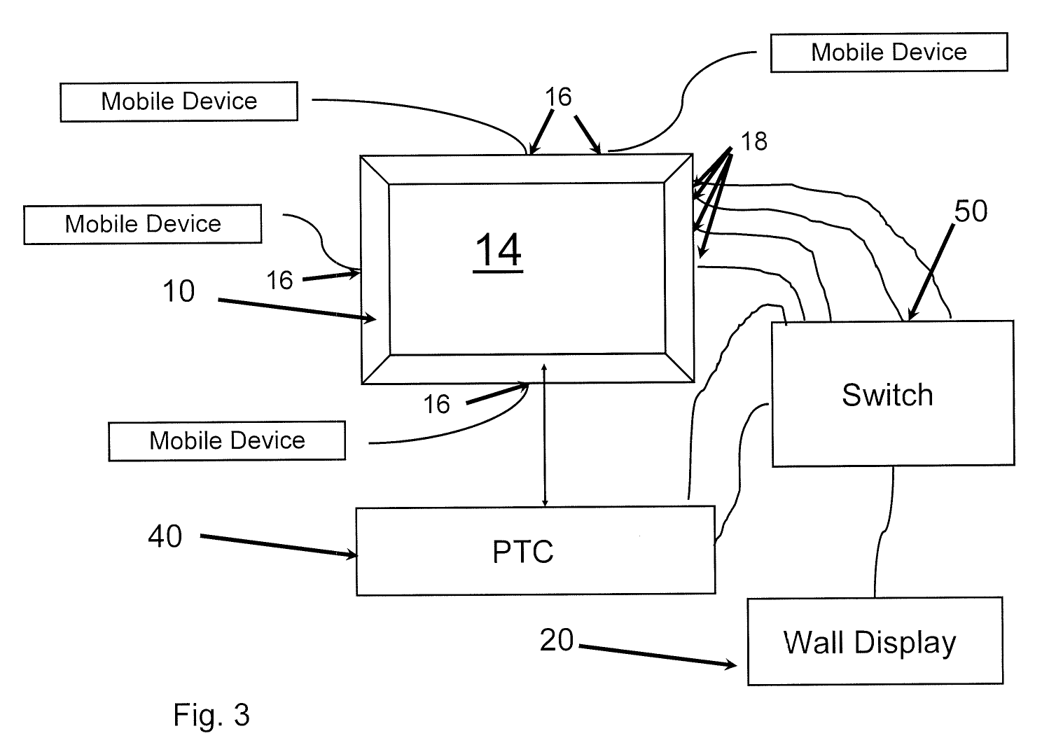

FIG. 1 illustrates a top down view of an embodiment including a touch screen 14, i.e., a table display, in a table 10 in addition to a wall display 20. FIG. 3 illustrates a top down view of another embodiment including the touch screen 14, i.e., a table display, in a table 10 and two wall displays 30.

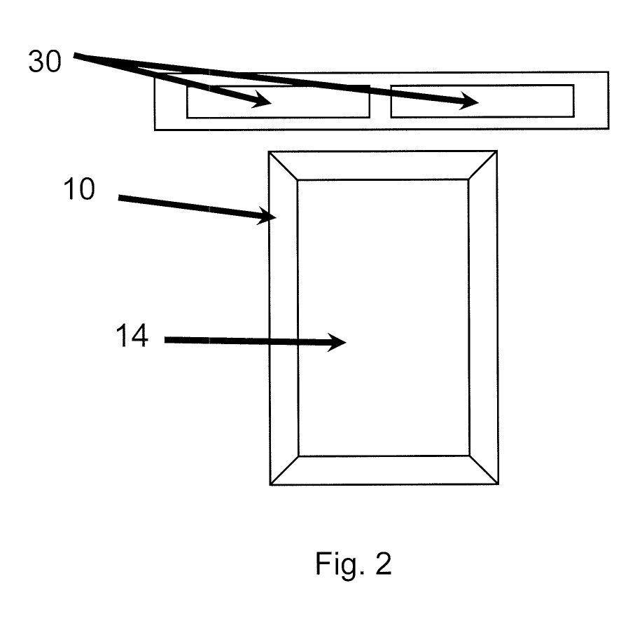

FIGS. 3 to 5 illustrate block diagrams of a network for use with the configurations of FIGS. 1 and 2 according to an embodiment. These block diagrams merely to illustrate connections between components and the placement of the components therein is not representative. Also, either wall display 20, 30 may be using in the configurations illustrated below.

As illustrated in FIG. 3, the touch screen 14 of the table 10 may cover most of the area of the table. A processor 40 connected to all associated displays, e.g., the touch screen 14 and the wall display 20, is referred to as the Primary Table Computer (“PTC”) 40. The PTC 40 may be connected to a network, e.g., by ethernet. The network may contain a wireless router. Other devices in addition to the PTC 40 may be on this network.

A switch 50, e.g., a 5-port vga switch, may also be located in the vicinity of the table 10. In particular, the table 10 may include inputs 16 and outputs 18 for connecting mobile devices to the switch 50. This switch 50 may be controlled by the PTC 40. In this manner, any mobile device, e.g., up to four mobile devices, may have content displayed on the Wall Display 20. Additionally, the PTC 40 may provide a video output to the switch 50, as well as a control signal. Further, under control of the PTC 40 to be discussed in detail later, content from one or more of the mobile devices may be displayed on the touchscreen 14. Using the switch 50 to provide all video signals to the wall display 20 may assist in making the touchscreen 14 and PTC 40 more readily integrated with a generic wall display.

In addition, the PTC 40 may run a software program (herein, “the TTMenu”) as disclosed co-pending, commonly owned U.S. patent application Ser. Nos. 12/222,670, 12/588,774, and 12/650,684, the entire contents of all of which are hereby incorporated by reference for all purpose.

When no mobile devices are connected to the switch 50, the wall display 20 and the table display 14 may show images generated by the PTC 40. For example, the PTC 40 may initially provide images explaining instructions for connecting mobile devices or other information.

In this manner, the table 10 can be configured to have multiple mobile device inputs 16 having outputs 18 connected to inputs of the switch 50. Multiple users may come to the table 10 and connect their mobile devices to mobile device connection 16 at the table 10. By hitting buttons on the touch screen 14, the content of the wall display and/or the touch screen 14 may be switched between the PTC 40 and any one of the multiple mobile devices connected to the inputs 16.

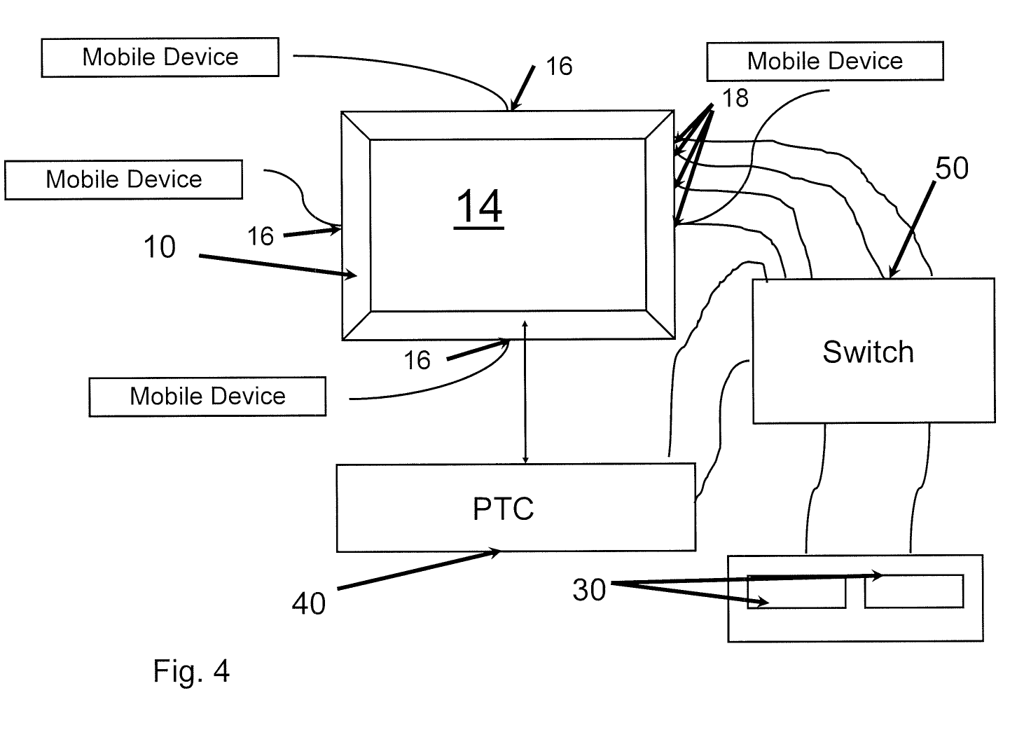

As illustrated in FIG. 4, when the wall display 30 is used, two outputs may be provided from the switch 50, here configured as a 5×2 switch, i.e., a video output for each wall display 30.

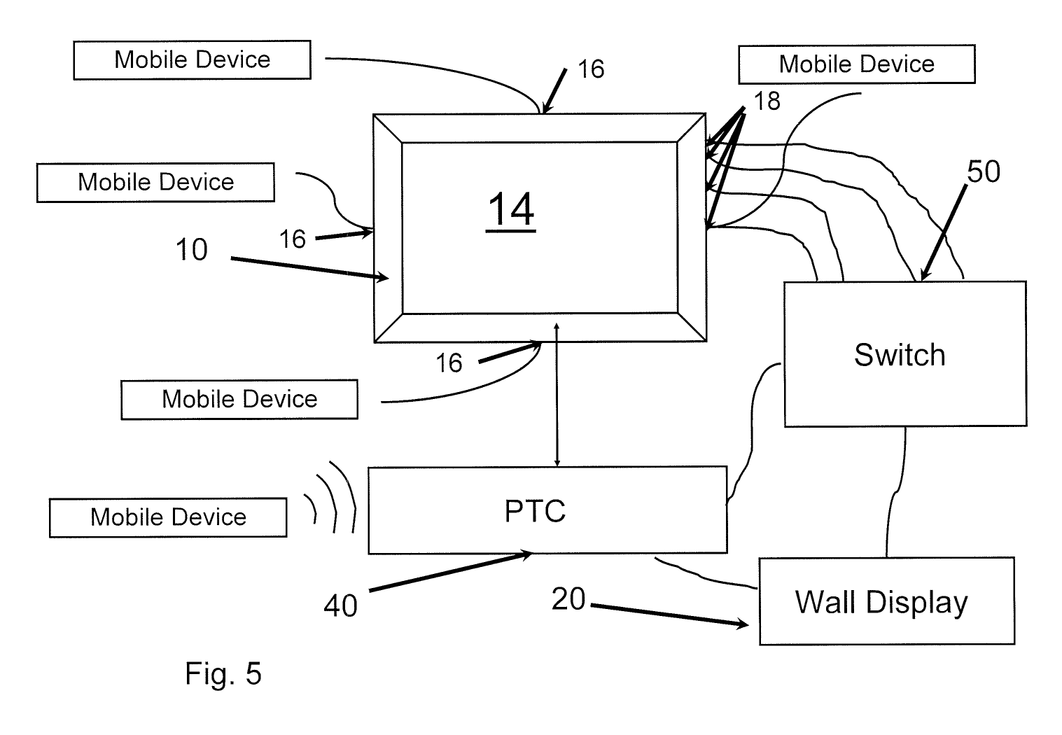

As illustrated in FIG. 5, the video output from the PTC 40 may be directly connected to the wall display 20, instead of through the switch 50. In other words, two input channels may be provided to the wall display 20, e.g., a PC input and an hdmi input. The hdmi input comes from the PTC 40. The PC input will come through the switch 50 from mobile devices connected to the switch 50. When no mobile device is connected to the switch 50, the wall display 20 may display the input connected to its hdmi input, displaying the content of the PTC 40 under control of the PTC 40, either through an IR signal or the ethnet. In this case the switch 50 may not be used.

When the switch 50 is not being used in the embodiment of FIG. 5 or when the

PTC 40 is to be displayed in the embodiments of FIGS. 3 and 4, the wall display 20 and the table display 14 may show images generated by the PTC 40. For example, the PTC 40 may initially provide images explaining instructions for connecting mobile devices or other information.

Further, as illustrated in FIG. 5, in accordance with an embodiment, the mobile devices may also be connected to the PTC 40 wirelessly. For example, operating systems of many new mobile devices have streaming or content sharing built in which may be employed for control of content displayed. For example, the iOS 5 for the iphone® and ipad® by Apple® has a built in function called Airplay®. Airplay® streams still images and/or audio/video and/or screen shares to Apple's Apple® TV product.

Typically, streaming from a mobile device only allows a single image or series of images to be displayed on another display. By using a table display application (TDA), discussed further below, a user may display the entire display on their mobile device or may upload particular folders/files onto the PTC 40.

In accordance with an embodiment, when a user connects a mobile device to the same network as the PTC 40, they can attempt to use a video streaming or content sharing application that is built in to the operating system of their mobile device. For example, for an Apple® mobile device, they could attempt to use Airplay®. When they do this, they will be shown a list of all AppleTV®s connected to this network. By configuring the PTC 40 to emulate a streaming video receiver, e.g., an AppleTV, and to have a specific device name, a user connected to the wireless network will see the specific device name associated with the PTC 40 listed. The PTC 40 may broadcast what services it supports, in addition to the specific device name. Once a user selects the specific device name on their mobile device, the user can be connected to the PTC 40.

If an actual streaming video receiver was employed instead of the PTC 40 emulating the streaming video receiver, then when a second mobile device attempted to connect to the video receiver when a first mobile device was already connected, the first mobile device would be disconnected and the content from the second mobile device would be displayed. For the first mobile device to connect again, the video receiver would need to be reselected, and the second mobile device would then be disconnected.

However, by simulating a video receiver in software, multiple devices may be connected at the same time. Each device can be displayed on the touchscreen 14 and by dragging icons representing the mobile devices displayed on the touchscreen 14 towards the wall display 20, which mobile device's content is displayed thereon may be changed, without having to reconnect.

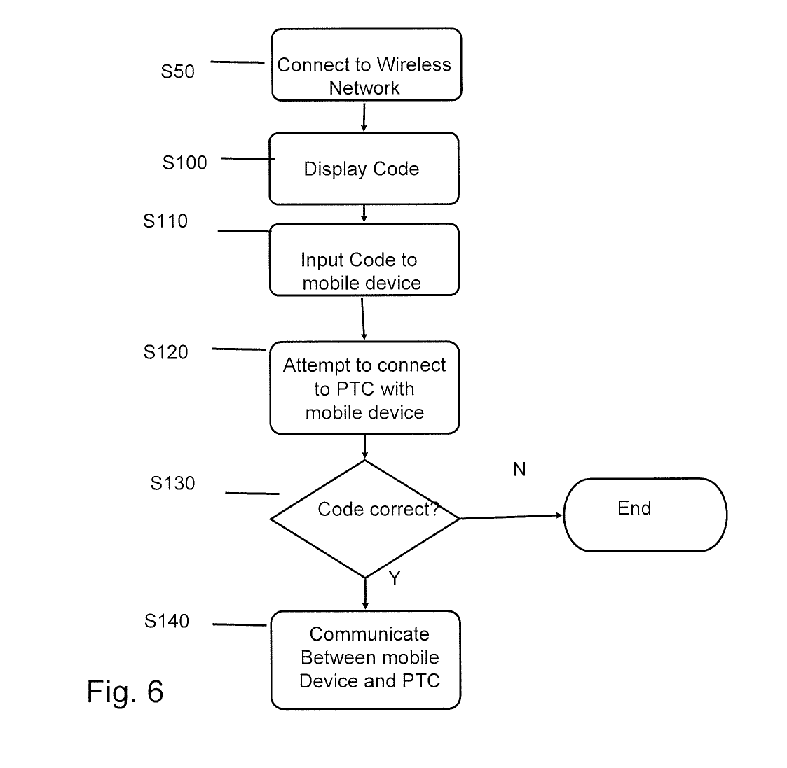

Before displaying information from the user's device on the touchscreen 14 and/or the wall display 20, whether the used is authorized may be determined. For example, in a public environment, it may be undesirable to allow users that are not seated at the table 10 to send content to the table display 14 or wall display 20. In order to authorize the user, there are several security options that can be employed, as illustrated generically in the flowchart of FIG. 6.

As illustrated in FIG. 6, in operation S50, first the mobile device connects to a wireless network having the PTC 40 thereon. In operation S100, a code may be displayed, i.e., on either the wall display 20, 30 or the table display 14, by the PTC 40. Depending on how the displays are mounted, it may be more secure to display the code on the table display 14, since the table display will typically be less visible to users that are not seated at the table.

In operation S110, the code is input to the mobile device. This input may be achieved manually, may use the mobile device's camera, may use another application already on the mobile device, and/or may require a table display application, as will be described in detail below.

In operation S120, the mobile device attempts to connect to the PTC 40. In operation S130, the PTC 40 determines whether the code provided by the mobile display is correct. If not, the process ends. If the code is correct, communication between the mobile device and the PTC 40 commences in operation S140, typically using the streaming capability of the mobile device. Streaming video techniques that are built in to operating systems are designed to work with low cost set-top boxes. For example, Airplay® is built in to the operating systems of most Apple® products and is designed to work with AppleTV®.

In contrast, in conventional systems using Airplay®, initially the AppleTV® is set up, typically with a remote control. During the set-up process the user can enter a password for Airplay connections. This password is typically not changed very frequently as it requires the use of a remote control and selecting options on a keyboard with a remote control. When a mobile device is connected to the same network as an AppleTV®, a user of the mobile device is provide with a list of the AppleTV®s on the network. If the AppleTV® had a password entered during the set-up process, the user is required to enter the password, which is not displayed at this time. Once the correct password is entered then the AppleTV® changes its full video output signal from internal video to the video that is streamed from the mobile device. In this manner, the content of the user's mobile device is displayed.

In contrast, by emulating a receiver, in operation S100, the PTC 40 may constantly display and update the code or may display the code in response to a request input via the touch screen 14. The code may be a password, a bar code such as a QR code, or a visual code created by the PTC 40 in response to placement of a mobile device on the table 10.

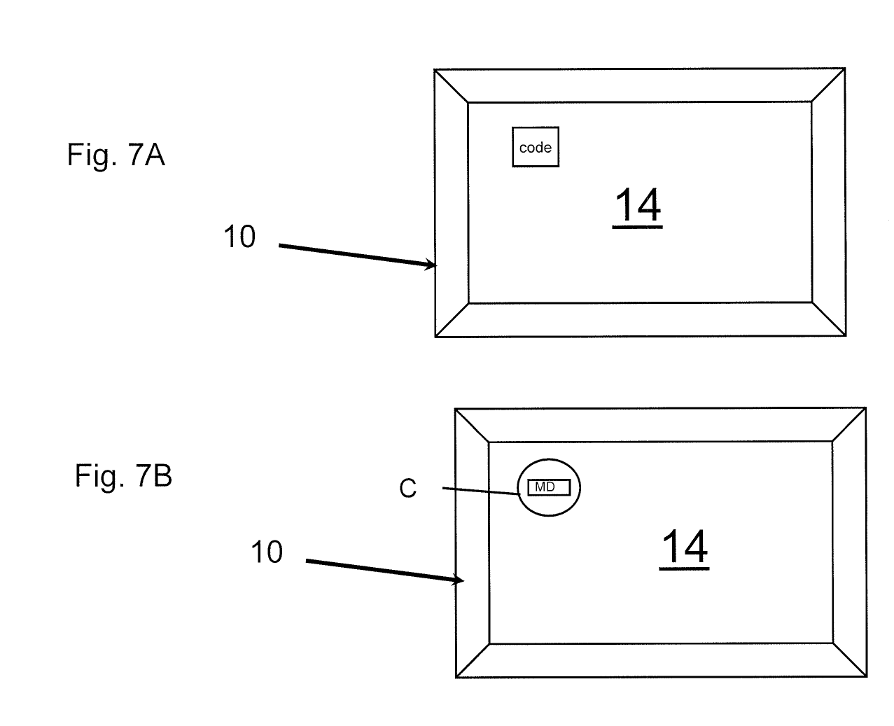

FIG. 7A illustrates a configuration for a code requiring space between the mobile device and display of the code. For example, if a password is used, the mobile device cannot cover the password. Once a password is displayed, the user can enter the password on their mobile device. The PTC 40 can be designed to periodically change the password for each user and store the password locally ensuring that the user is actually sitting at the table. This approach is the simplest and does not require anything to be downloaded onto the mobile device.

In streaming video or content sharing applications that are in operating systems of mobile devices, such as Apple's Airplay® mirroring, once the application is chosen and the particular computer, i.e., the PTC 40, is selected there is an option for the user to select a password associated with the PTC 40. For an AppleTV® and for devices that are typically designed to work with Airplay® mirroring and similar applications, this password is typically chosen at set-up and is not changed frequently, since it is not easy to change this password. However, in this embodiment, since the PTC 40 is emulating an AppleTV® or other streaming video receiver, the password for the streaming video application may be changed rather easily and therefore may be frequently changed, e.g., many times per day.

In this embodiment, the PTC 40 is reset periodically, e.g., after inactivity or when a new session is started, when new users sit at the table. When this happens, the PTC 40 will reset the streaming video password, assuring a secure connection and preventing previous users that are no longer sitting at the table from connecting to the PTC 40. Further, content associated with a previous session may be deleted.

Another option for obtaining a code in operation S100 is use of a bar code, e.g., a quick response (QR) code. When a QR code is displayed on the table display 14, as illustrated in FIG. 7A, a camera in the mobile device can take a picture of the QR code. Reader applications for QR codes are ubiquitous. The QR code detected by the reader application on the mobile device then directs the user to a specified website. In particular, each QR code could be unique to each table, to each request, and/or each session. Each unique QR code would take the user to a different web address. Every time a new QR code is read, the mobile device would be directed to a unique URL address which can act as a key (embedded password) for the PTC 40. Then, when the PTC 40 detects a device trying to access it, with the correct key, the PTC 40 determines that the device just received the QR code. This website could obtain a key from the mobile device. Then, the PTC 40 can note a particular characteristic of the mobile device, e.g., a MAC address, an IP address, a device name, and so forth. Once this happens, the PTC 40 can instruct the user to share information with the table system. The user can then follow the instructions to share content with the PTC 40. Content may be shared using built in features of the operating systems of the mobile device, e.g., Airplay with iOS. When the user tries to stream information to the PTC 40, the PTC 40 will check the MAC address or ip address of the mobile device to make sure it is valid. If so, the PTC may then allow content to be shared.

Another alternative when using a bar code or QR code is to use a table display application (TDA) downloaded onto the mobile device. The TDA is different than applications noted above in the related art, since the TDA will not digitize the mobile device's video output and stream it. Instead, this application will utilize the streaming function built in to the operating system. By using the TDA, security can be very robust and not be dependent on an operating system of a particular mobile device. The QR code could automatically direct the user to a website that would ask whether the user wants to download the TDA. Alternatively, instructions, including a website from which the TDA can be downloaded, could be displayed, e.g., on the touchscreen 14. Once the TDA is downloaded or otherwise on the mobile device, a QR code would be displayed again, either the same or a new QR code, to obtain the key information.

Another alternative to connect wirelessly using the TDA is illustrated in FIG. 7B. Here, the mobile device may be placed on the touchscreen 14, with a camera therein facing the touchscreen. A user may request connection by interacting with the touchscreen 14, e.g., by drawing a circle C around the mobile device or by placing the mobile device within a region indicated on the touchscreen 14. Alternatively, the touchscreen 14 may automatically detect the presence of the mobile device. The table display 14 may display a time sequential code, e.g., a series of colors, within the circle. The mobile device detects the code and then tries to connect to the PIC 40 using the code.

Using this contact embodiment may simplify determination of where the content came from when multiple devices are supplying content, as well as simpler detection when the mobile device is removed. Once the mobile device is removed from the table, pictures/data associated with that device can also be removed instantly or after a delay, either predetermined or user selected.

Multiple mobile devices connected to a single computer

With some operating systems, e.g., the current operating systems of Apple® products, only one mobile device at a time can be connected to each receiver. So, if the PTC 40 only emulates a single receiver, only content from one mobile device can be displayed at a time. As soon as another mobile device is connected, then the content from the former device is no longer displayed, i.e., is replaced with the content of the latest device to connect.

According to embodiments, instead of using set-top boxes, the PIC 40 is configured to receive the signal from the mobile device(s). The PIC 40 may also combine the signals and reformat them. The PTC 40 can be configured to simulate a set-top box, so that it can receive signals from streaming video or content from mobile devices. When the first mobile device is connected to the same network as the PTC 40, the first user can “connect” their device with the security measures and procedures described above.

When subsequent mobile devices are connected each mobile device can be assigned a different thread by the PTC 40. Then the PTC 40 can send content from any one of the mobile devices wirelessly connected to it, to the wall display 20, 30, thereby emulating a simple switch, or the PTC 40 may combine multiple video streams together, resample the video stream, and send the resampled stream to the wall display 20, 30.

For example, if four ipads® are connected wirelessly to the PTC 40, each with 1080p resolution, the PTC can down sample the video signals to ½ the resolution in each direction. Then, the PTC can combine the four video signals forming a full 1080p video signal with four quadrants and the contents of one mobile device video stream in each of the four quadrants. In this manner, the wall display 20, 30 may be effectively divided in to four quadrants, with each quadrant displaying the video content of a different mobile device.

Multiple Table Environment

One option for wireless connections in an environment having multiple tables includes having a unique wi-fi hot spot for each table 10. In many cases, each PTC 40 will have wi-fi capability. Each PTC 40 can be configured to be its own wi-fi hot spot. While this option is simple and low cost, security and ease of use are compromised.

When using unique wi-fi hot spots for each PTC 40, when the instructions are displayed at the table 10, the user will be instructed to connect to a specific wi-fi network. For example, if twenty tables are in range of the mobile device, twenty different wi-fi networks may be displayed each labeled 1 through 20. If the user is seated at table 12, the instructions may instruct the user to connect to the wireless network called “Table 12.” Once connected to the network, the user can scan a code as described above and will then be instructed to play a slideshow or video on their device. Once they play the slideshow or video, they will then get a prompt on their device to select the name of the PTC 40 for “Table 12”. In other words, the selection of the table must be performed twice.

Alternatively a single wireless router can be used for many tables. This simplifies the user connection, in that they will not see as many wireless routers when they try to connect to the network and selection only needs to be performed once.

For example, when using the QR code, the user would be instructed to connect to the wireless network named, for example, Tables 1-10. An instruction may then be displayed, e.g., “Start the TDA on your mobile device or scan the QR code below to obtain the app and press the button here once it is downloaded and you have started the TDA on your mobile device.” Once read, the QR code would start a download to your mobile device and the website the QR code directs to is associated with the appropriate PTC 40. Once the TDA is running, the QR code would be need to be scanned again to send the correct information to the PTC 40.

Also, the TDA may be used with either multiple or single wireless access points to facilitate additional security, e.g., a firewall, such as a vpn, between the wireless access points and each PTO 40.

Hard wired vs. wireless connections

With a wireless connection via a digital streaming video function, the PTC 40 receives a digital video signal so that it can sample the video stream, combines the sampled video signal with other videos and display it on the Table Display or the Wall Display. However, if a mobile device is connected with a typical continuous video adaptor such as a VGA connector, then a continuous video display would be transmitted to the PTC 40. In this case in order to implement many of the functions in the embodiments, the PTC 40 would need to digitize the input from the VGA adaptor or other similar video connector. If more than one mobile device were to be connected at the same time, then the PTC 40 would be required to simultaneously digitize multiple video streams. This is difficult for a single computer along with the other functions required.

In order to combine multiple video streams as combined above, the video streams may be digitized prior to transmission to the PTC 40. This can be achieved, for example, by having each mobile device digitize its video output and stream it to the table computer as in the case of a streaming application such as Airplay® described previously.

However, some mobile devices may not have a streaming video application integrated in to its operating system. In this case, in order to convert the continuous video signal to a digital streaming video, a digital scaler box may be used.

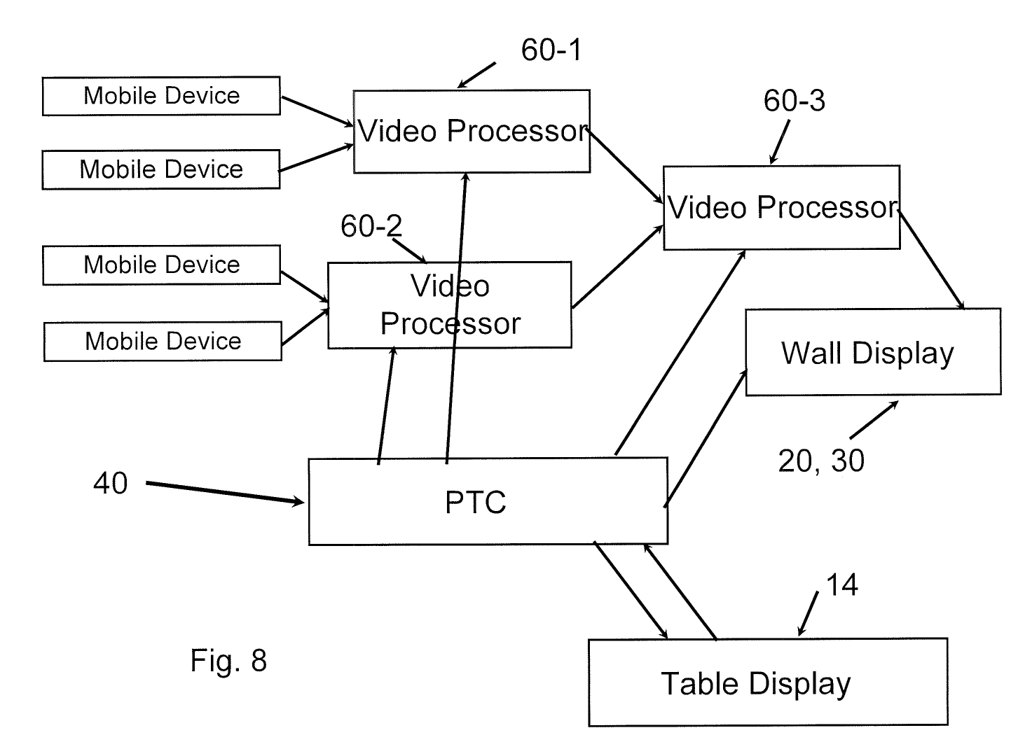

For example, an example of a video processor is a 1T-C2-750 scaler processor made by TV One. This processor can superimpose two inputs onto one output. For example, video processors 60-1 to 60-3 may be cascaded as shown in FIG. 8, so that four video signal inputs may be superimposed on a single output video signal. This processor has dvi inputs and outputs. A dvi to hdmi converter cable can be used to provide an hdmi signal to the wall display 20, 30. VGA to dvi converter cables may be used to connect the mobile devices to the processors 60-1 to 60-3.

The processors 60-1 to 60-3 may be configured by rs-232 or IR controls.

Therefore, the processors 60-1 to 60-3 may be electronically configured to accept each of its four inputs as 1920×1080 signals or other tv or pc 2-d video signals.

In this manner, the processors 60-1 to 60-3 may be configured to scale each of the input signals by a factor of 0.5 in each direction and superimpose each of these one on one quadrant of the output signal. This will result in an output signal composed of the four input signals, one in each quadrant. When this signal is sent to the wall display 20, 30, all four signals may be displayed on the wall display 20, 30 simultaneously.

In one embodiment, multiple video processors 60-1 to 60-3 may be integrated in to a table. Digitized video signals are input to the PTC 40. The video signals may be digitized either by the mobile device from which they originated (e.g. a streaming video application) or by a video digitizer.

In this manner, multiple mobile device displays can be combined and displayed on the table display 14 or the wall display 20, 30, where some mobile devices are connected wirelessly and some through wired adaptors, including analog video adaptors, such as vga connectors.

Video Conferencing

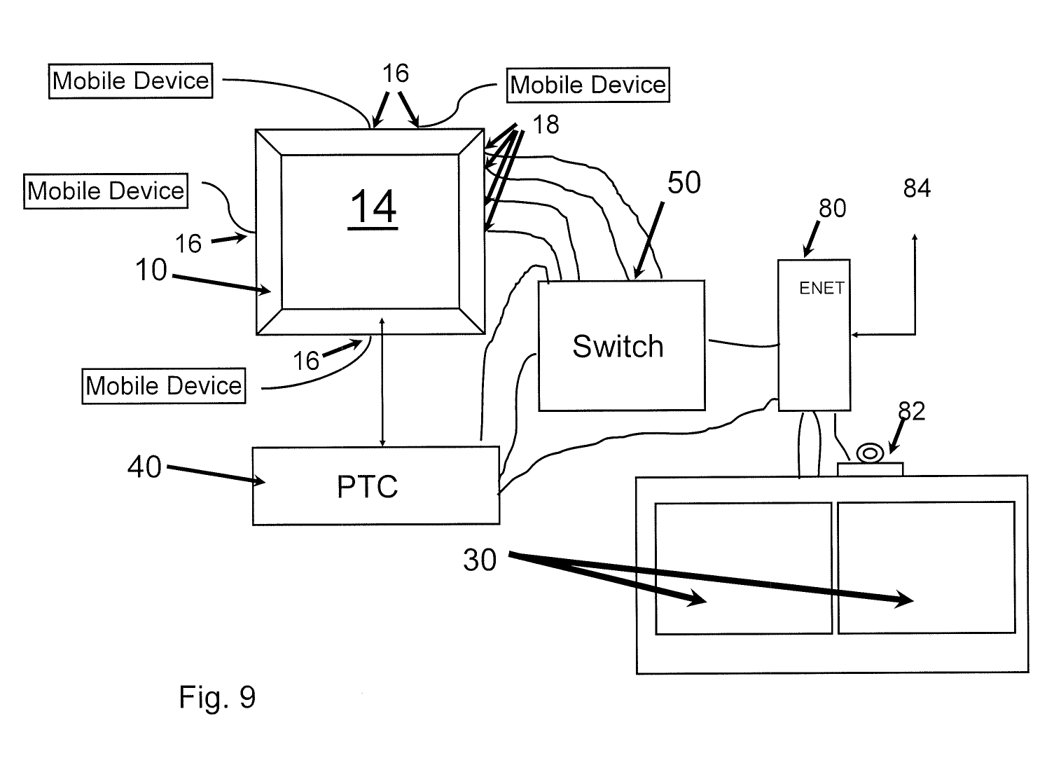

As illustrated in FIG. 9, video conferencing capabilities may be readily incorporated into the system in accordance with embodiments, by providing, for example, a video conferencing processor 80 and a camera 82. The video conferencing processor 80 may be connected to the switch 50, the wall display 30 (or 20), the camera 82, and a remote feed 84. The camera 82 may be positioned on the wall display 30. The PTC 40 may also control the video conferencing processor 80 and control what is displayed on the wall display 30. For example, one of the wall display 30 may display content being discussed, while the other wall display 30 may display an image from the remote feed.

Use of the Touch Screen

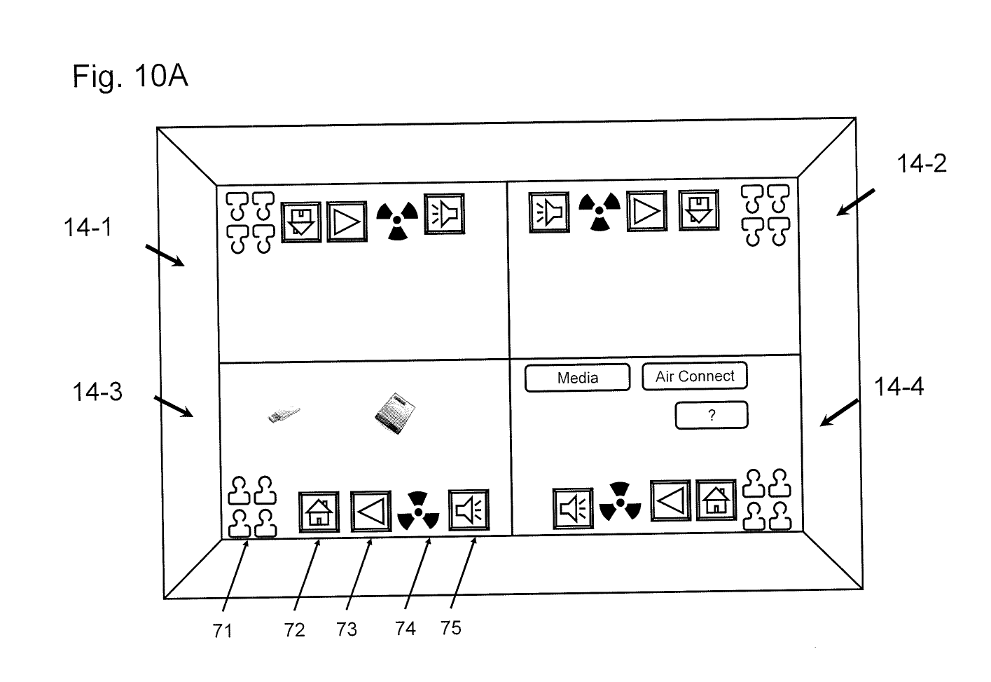

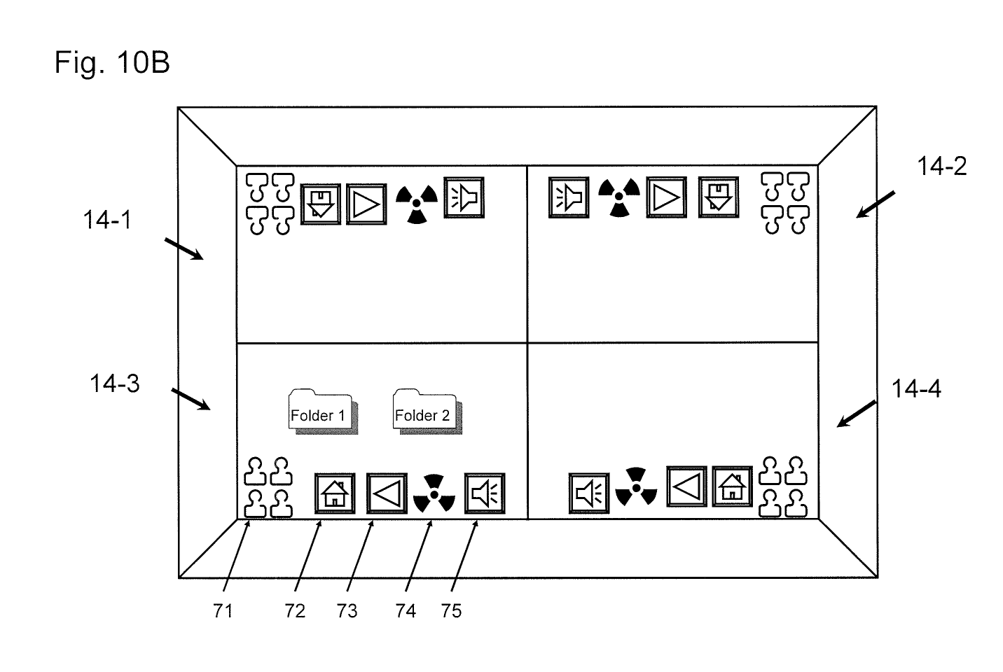

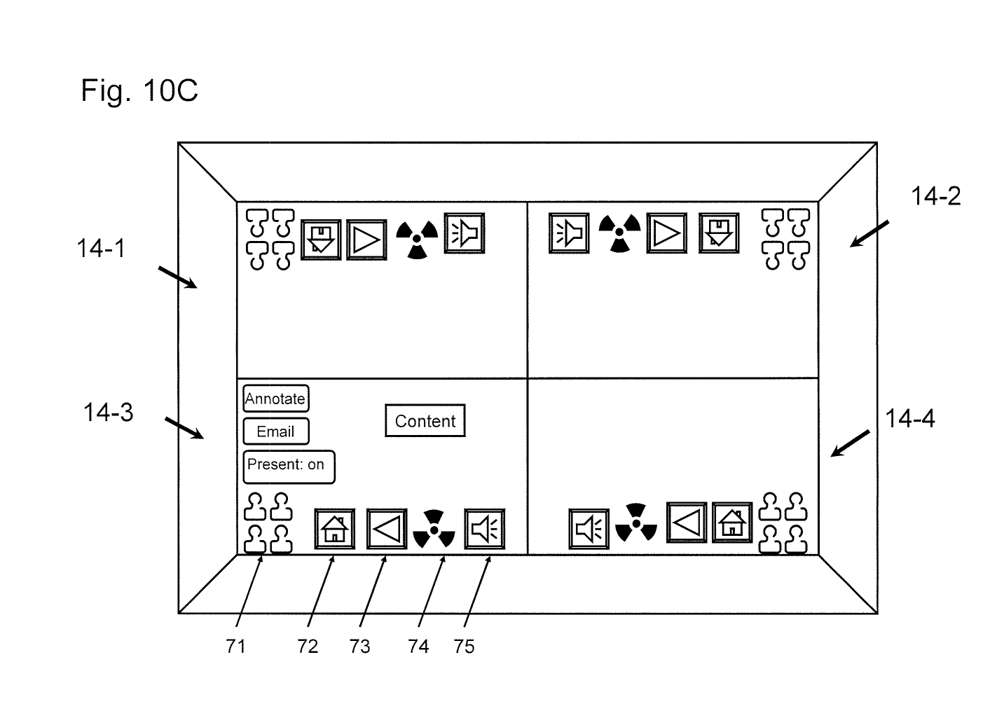

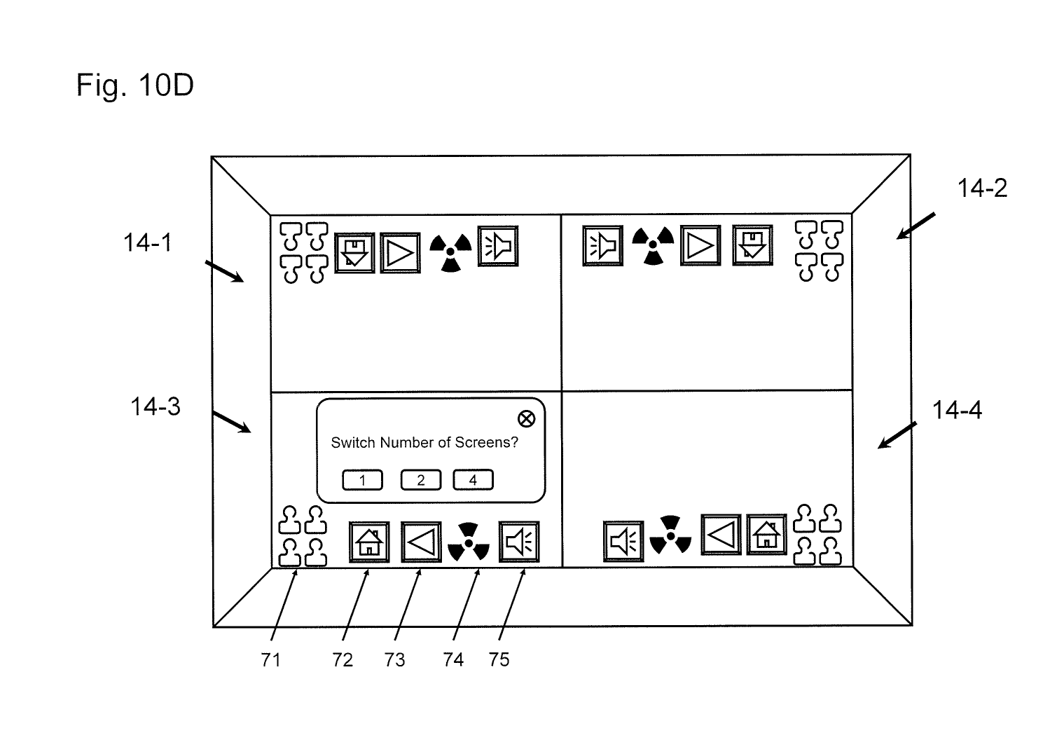

In any of the embodiments above, control of the wall display 20, 30 and the table display 14 may be provided through the use of the touch screen in the table 10. Certain icons may be displayed at all times on the touch screen, regardless of what else is displayed thereon, e.g., may be to the side of or superimposed on content being displayed. For example, as illustrated in FIG. 10A, the touch screen 14 may always display core icons, e.g., a screen number icon 71, a home icon 72, a back icon 73, a session end icon 74, and a volume icon 75. When the touch screen includes multiple display sections, e.g., four sections 14-1 to 14-4 as illustrated in FIG. 10A, each section may display these core icons at all times.

When the home icon 72 is selected, then additional options may appear, as illustrated in section 14-4 in FIG. 10A. For example, a media button, an air connect button, and a “?” button may appear. Selecting the air connect button may begin the wireless connection process noted above. Selecting the “?” may display answers to frequently asked questions and further help issues. Selecting the media button may result in the display shown in section 14-3 of FIG. 10A. In section 14-3 of FIG. 10A, a user is presented with the option of selecting content stored in media connected via a USB port or locally on a mobile device.

Selecting one of these locations may then allow a user to select from different folders or files stored at that location, as illustrated in section 14-3 of FIG. 10B. Selection of a particular file or folder may then reveal more options, as illustrated in section 14-3 of FIG. 10C. For example, the use may email or annotate the presentation. Selecting the present button may toggle between having the content being displayed on the wall display (“on”) or not (“off”).

When the screen number icon 71 is selected, any user may change the number of screens being displayed on the table display, as illustrated in FIG. 10D. The altered number of screens may be oriented in a direction from which the selection was made.

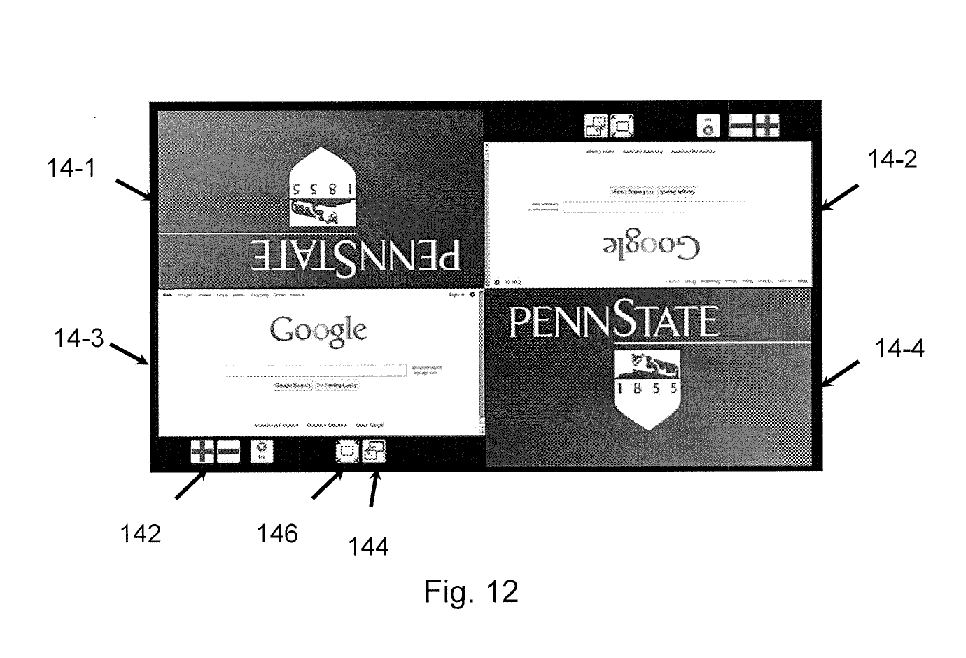

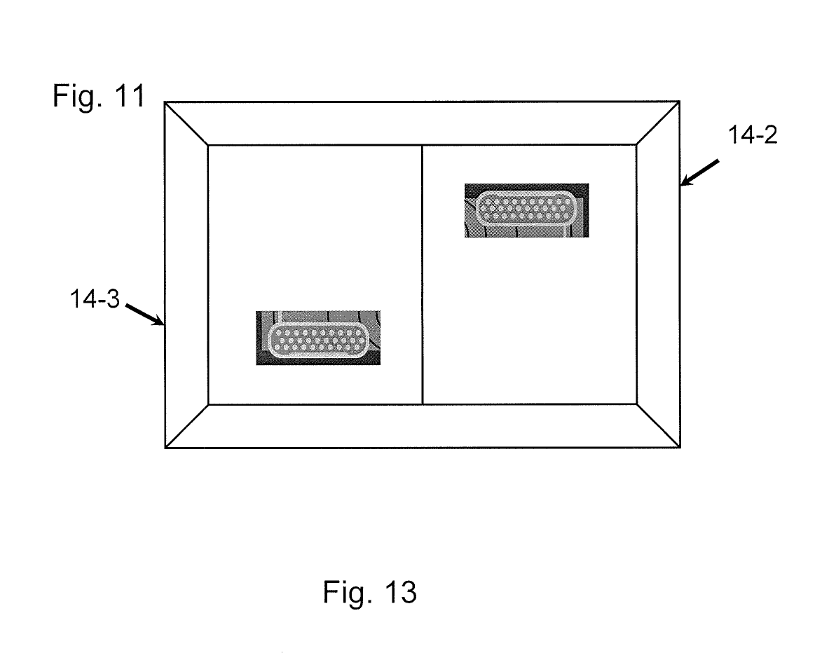

As noted above, the table display 14 may be divided in to multiple sections, e.g., screen sections 14-1 to 14-4. Each section 14-1 to 14-4 can be operated differently, i.e., separately and independently, by different users. Each user can select an application. Examples of applications include web browser (FIG. 12); virtual keyboard (FIG. 13); annotation applications (FIG. 10D); whiteboard applications; share laptop applications, and so forth.

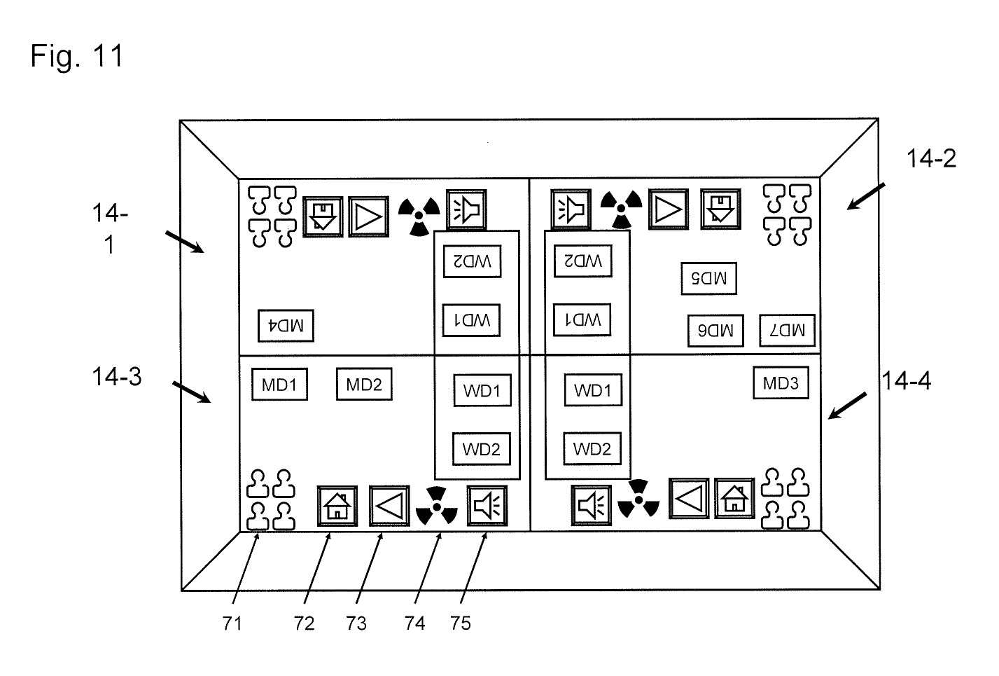

The touch screen 14 may be used to select from different mobile devices connected to the PTC 40. For example, if there are two wall displays 30 and four connectors 16, 18 for mobile devices, at a given time four mobile devices may be connected to the PTC 40. Additional mobile devices may be connected wirelessly to the PTC 40. As illustrated in FIG. 11, the touch screen 14 may display many small versions of each of the device MD1 to MD7s connected to the PTC 40. For example, the touch screen 14 may display four of the seven devices (MD1 to MD7) connected, each in a section of the touch screen 14. In this manner a user, may view the display of four of the seven devices connected to the touch screen 14.

Tapping on one of these four sections, may then cause the corresponding device to be displayed on the wall display 20, 30 (WD1 to WD2). That is the corresponding mobile device's screen contents may be displayed on the wall display 20, 30. This may be a live video stream of the contents of the mobile device to the wall display 20, 30.

Tapping a different section corresponding to a different mobile device or dragging a particular mobile device to the wall display icon on the touchscreen, may cause a different mobile device to be displayed on the wall display 20, 30.

To see other devices on the touch screen 14, a scrolling gesture on the touch screen 14 may cause the contents of other mobile devices to be displayed on the touch screen 14.

In this manner, a user can quickly view the contents of all mobile devices connected to the PTC 40, scroll through the contents, and chose what is to be displayed on the wall display.

Web Browser Application

There is a need for a web browser app for use by multiple users in a collaborative manner. Each user may be able to browse and view websites independently without interfering with each others web sessions, yet still be able to periodically share info displayed on the websites with the other users.

According to an embodiment, each screen section 14-1 to 14-4 has its own web browser. If there are four screen sections, there may be four users, each user using a different screen section. Then each user may select the web browser app, which would display a web browser in each of the four sections.

In the initial mode, in each of the screen sections 14-1 to 14-4, the web browser may occupy about 90% of the space displayed in the screen section as shown in FIG. 10, forming a display window frame. The display window frame may be equal to the size of the screen section of slightly smaller.

When a web site is selected, the PTC 40 may display the web site within the display window frame. As shown in FIG. 10, the screen section may also contain control buttons, e.g., zoom buttons 142 for zoom (+and −) (or an equivalent gesturing); a publish 144 for publishing to secondary screen (two screens with arrow between), and an expand button 146 (arrows extending from the four corners). When the zoom buttons 142 are tapped, the size of the content within a website is expanded, but the web page stays within the confines of the window frame.

Each screen section 14-1 to 14-4 may be limited to displaying one website at a time, or may display multiple websites and contain multiple display window frames. However, in the initial mode, all websites in one screen section is confined to stay within the area of the given screen section. In this manner, even if a user zooms in or expands a web page, this zoom will not interfere with the web pages being viewed by users, using other screen sections.

Within each screen section, each screen section acts like a conventional desktop with a touch screen interface. So, within a single screen section only one web page may be active at a time. However, if users in different sub sections have different web sites active, then multiple web pages may be active at the same time.

When a user taps the expand button 146, the website or other content in the corresponding screen section maybe expanded to cover the entire or nearly the entire primary screen, i.e., all screen sections 14-1 to 14-4. Then the expand button 146 may change to a collapse button. Tapping the collapse button will then cause the website or content to revert back to the previous mode, so that each user may operate again within their own section.

This is contrary to normal operation of touch screens. With normal operation, each user can expand or zoom content anywhere on the screen. However if there is more than one user, and each user has their own “window”, each user can expand their own window to any size. Thus if one user wants to zoom in on the content in their window by expanding their window they can do so, even if it covers up others' windows, because the computer has no way to differentiate which windows belong to each user.

Secondary Screen

Hitting the publish button 144 will send the web page being viewed in the particular screen section to the secondary screen, e.g., the wall display 20, 30. In order to do this, a separate web page may be opened and displayed on the secondary screen. The computer can display the same website being displayed on the corresponding screen section, by navigating to the same web address within the web browser displayed on the secondary screen. The computer may track all user interactions (taps, drags, etc) made by the user in the corresponding screen section after navigation to the particular web address, so that not only may the same website be displayed on the secondary screen, but also the same content within the website, e.g., videos, slideshows, etc. In addition, once the website is displayed on the secondary screen, any user interactions on the primary screen can be tracked and mimicked on the secondary screen. The computer basically synthesizes mouse events on the secondary screen to match those on the primary screen.

Volume

If there is one computer driving both the primary and secondary screen, then there would be two web sessions active displaying the same thing. However, there will be a slight delay between the two sessions. This will cause a problem if audio is playing. Audio from both sessions would be heard, but a small delay on one of them.

According to embodiments, there are two ways to solve this problem:

First, when using the PTC 40 to drive both the primary and secondary screens, the publish button 144 will trigger the following action from the PTC 40. Instead of creating a duplicate session on the wall display 20, 30, the PTC 40 will just move the web session off of the table display onto the wall display 20, 30. In particular, the active web session will be displayed on the wall display 20, 30, while a static image of the webpage (updated for each new webpage).

The publish button 144 may also expand the window for this session to fill the entire wall display 20, 30. The touchscreen 14 may display control buttons including zoom buttons and movement buttons, which will now control the size and position of the web session on the wall display 20, 30. The control buttons may also include a button to bring the active web session back to the table display 14 (“grab” button). While the wall display 20, 30 displays the active website, the touchscreen 14 is still used to navigate to other websites or activating other media on the website. In other words, the touchscreen 14 is still the input device.

Alternatively, in addition to the PTC 40, another computer may be located in the wall display 20, 30. In this case, when audio is playing from the computer of the wall display 20, 30, the volume on the PTC 40 may be muted.

Virtual Keyboard

A virtual keyboard when multiple sessions are present is difficult to realize, especially in the presence of potential web browsers or web pages on some of the screen sections. A method according to embodiments allows multiple virtual keyboards on the touchscreen system described above.

Computers are designed to operate with a single keyboard at a time. If more than one keyboard is plugged into a single computer at the same time, then all keyboards will send their keystroke inputs to the same location. To have more than one virtual keyboard requires simulating keyboards in software. As illustrated in FIG. 11, a different virtual keyboard can be generated for each section 14-1 to 14-4 of the table display 14, here shown in sections 14-2 and 14-3. If a user touches a text field in a web browser or other app, the software program will request the virtual keyboard associated with the corresponding screen section, evoking a virtual keyboard that the program can display in the screen section containing the web browser. Each virtual keyboard can operate as a separate object within the program. However, the PTC 40 contains a single keyboard component, i.e., the system keyboard. When a virtual keyboard is evoked, a simulated key event is generated and sent to the system keyboard, and the system keyboard sends its output to the appropriate location within the web browser in the corresponding screen section. If the user touches somewhere else on the screen section, the virtual keyboard may be hidden.

In this manner, multiple virtual keyboards may be displayed on the primary screen and used at the same time by multiple users, where each keyboard is associated with a particular screen section. The program may then cause the System Keyboard to continually change the location of its output, depending on the particular virtual keyboard generating the simulated key events.

Note that with conventional programs there is typically one keyboard. If a user touches a web browser in a text field, then typing on a keyboard will send characters from the keyboard to the web browser. Without use of the system keyboard described above, if multiple keyboards were used, all would send their outputs to the same text field in the same web browser.

Dividing the Wall Display

Further, different mobile device contents may be connected to the two wall displays 30 illustrated in FIG. 3, allowing users can compare the contents from two different mobile devices thereon. On the Table Display can be representations of each of the two wall displays 30 (FIG. 11). Dragging a section representing one of the mobile devices to one of the wall displays 30 representations may cause the corresponding mobile device to be displayed on the corresponding wall display 30.

Furthermore, one or both of the wall displays 30 can be divided in to sections. For example, a wall display division icon can be placed on the table display. Tapping on this icon may ask the user if they want to divide the wall display 30 into, e.g., one, two, or four sections. Selecting one of these options may cause the wall display 30 to be divided in to the number of sections chosen.

For example, if one of the Wall Displays is divided in to 4 sections, then the Wall Display may be divided in to 4 quadrants. Each quadrant may be connected to one of the mobile devices connected to the Table Computer. In this manner, on each quadrant of the Wall Display may be displayed the contents of a different mobile device. So that users may view the contents of four mobile devices simultaneously on a single Wall Display.

The Table Display can be used to choose which mobile devices are displayed on the Wall Display and how many are displayed on each Wall Display.

In addition, if, for example, two mobile devices are chosen to be displayed on a single wall display and if the wall display has a 16×9 format and if the two mobile devices are streaming videos each in a 16×9 format, then the two mobile devices will not be able to be simultaneously displayed in their entirety on the Wall Display unless at least one of these was reduced to one quarter of the area of the Wall Display or smaller.

However, it may be desired to divide the screen into halves instead quarters so that the display of the mobile device screen streaming videos is larger than a quarter of the area of the wall display screen. In this case, one or both of the ½ sections may display only a portion of the video that is streamed from the mobile device. In this case, the table display 14 can be used to shift the portion of the video stream that is displayed on the wall display.

Display of Mobile Device Contents on the Table Display

In addition to displaying the content of mobile devices on the wall display, content of mobile devices may also be displayed on the table display 14. This can be achieved in a manner similar to that described above for the display of the content on the wall display.

However, when displaying content from mobile devices on the table display, since the table display is a touch screen display, buttons and other icons on the table display may be superimposed along with the content from a mobile device, e.g., as illustrated in FIG. 10C.

For example, a software program similar to that used in U.S. Patent Applications referenced above may be run on the PTC 40. This program allows the table display 14 to be divided in one, two, four, or more sections. For example, if the table display 14 is divided into four sections, each section may display a navigational menu, allowing four users to use the table simultaneously. One user may use one of these four sections, e.g., 14-1, and another user another section 14-3. One user may chose to use a whiteboard application or access one mobile device and another user a different mobile device. When accessing a mobile device, the contents of the mobile device may be displayed within a frame or border, where the frame contains icons that trigger various actions.

The actions that may be triggered by tapping on these icons may include:

expanding a section of the screen over the entire Table Display or publishing the contents of a mobile device to the Wall Display or a section of the Wall Display.

Wall Display as a Touch Screen

In addition to the table display 14 being a touch screen, the wall display 20, 30 may also be a touch screen. Similarly to the table display 14, when the wall display 20, 30 is a touch screen, icons for various actions may be superimposed on the content from mobile devices on the wall display 20, 30.

Network of Multiple Tables

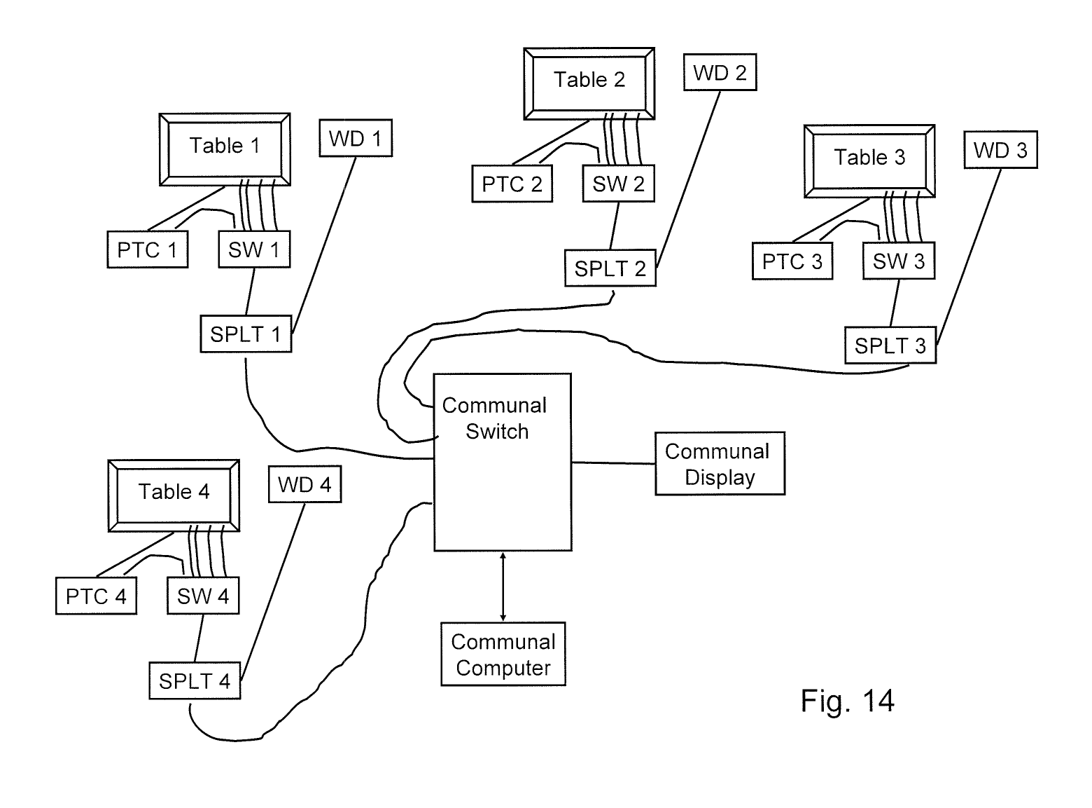

In another embodiment, multiple tables may be networked together, where each table has an individual PTC 40. For example, as illustrated in FIG. 14, assume there are four tables table 1 to table 4, each with a PTC., PTC 1 to PTC 4, and each with four hardwired connections. Each table may also have many mobile devices connected wirelessly as described above.

As illustrated in FIG. 14, the network further includes a communal switch, here a 4×1 switch receiving outputs from each table. The output of the communal switch is connected to a communal display. The video cable on each of the four tables that connects the output of the local switch, i.e., SW 1 to SW 4, to the local secondary display, i.e., WD 1 to WD 4, has a splitter, i.e., SPLIT 1 to SPLT 4, to provide an additional output to the communal switch.

The communal switch may be controlled by a communal computer, which may be on the same wireless network as the four tables. A user can then use a mobile device to control the communal switch and thereby change the contents on the CT to that of any of the 4 tables.

If two communal displays are used, the same method can be use with a communal 4×2 switch.

If multiple users are seated at each of multiple tables all connected on a single network, then it may be desirable for a user at one table to view not only the content from mobile devices connected to that table but also devices connected to other tables. For example, video information displayed on the wall display 20, 30 may be transmitted to other tables. Here, a splitter may be used to provide the output of the communal switch to each wall display WD 1 to WD 4. Therefore, instead of or in addition to a communal display, all wall displays may display the same content.

By way of summation and review, embodiments provide a product with wireless connectivity options that are secure and provide an ease of use comparable to that of the current approaches. Embodiments also provide increased flexibility in a collaborative setting for both individual use and sharing.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system, comprising:
a table with multiple user stations;
a touch screen embedded in a top surface of the table;
a table computer connected to the touch screen; and
at least two mobile device connectors connected to the table computer and configured to be connected to a secondary screen viewable from the multiple user stations, wherein
touching the touch screen at appropriate locations results in selection of content from a mobile device connected to the first mobile device connector, content from a mobile device connected to the second mobile device connector, and content from the table computer to be sent to at least one of the touch screen and the secondary screen for display thereon, and
touching the touch screen at other appropriate locations results in another function in addition to selection of content for display.

2. The system as claimed in claim 1, further comprising a switching box, the table computer and the at least two mobile device connectors being connected to the switching box.

3. The system as claimed in claim 2, wherein the switching box configured to receive an output from video conferencing equipment, wherein, during operation of the video conferencing processor, the video conferencing processor receives content from a remote location.

4. The system as claimed in claim 3, wherein the table computer is configured to control the video conferencing equipment.

5. The system as claimed in claim 4, further comprising a camera focused on at least one of the multiple user stations, the camera outputting an image to the video conferencing processor.

6. The system as claimed in claim 5, wherein touching the touch screen at the appropriate locations results in selection of content from a mobile device connected to the first mobile device connector, content from a mobile device connected to the second mobile device connector, content from the table computer, content from the camera, and content from a remote location to be sent to at least one of the touch screen and the secondary screen for display thereon.

7. The system as claimed in claim 1, further comprising a video conferencing processor, wherein the at least two mobile device connectors and the table computer are connected to the video conferencing processor, wherein, during operation of the video conferencing processor, the video conferencing processor receives content from a remote location.

8. The system as claimed in claim 7, wherein touching the touch screen at the appropriate locations results in selection of content from a mobile device connected to the first mobile device connector, content from a mobile device connected to the second mobile device connector, content from the table computer, and content from a remote location to be sent to at least one of the touch screen and the secondary screen for display thereon.

9. The system as claimed in claim 8, further comprising a camera focused on at least one of the user stations, the camera outputting an image to the video conferencing processor.

10. The system as claimed in claim 1, wherein the at least one additional function includes web browsing.

11. The system as claimed in claim 10, wherein the table computer, when operating, divides the touch screen display into multiple sections and allows simultaneous, independent web browsing in each section.

12. The system as claimed in claim 11, wherein the table computer, when operating, allows an image in a section to be published to the secondary screen.

13. The system as claimed in claim 1, wherein the table computer, when operating, connects to mobile devices wirelessly.

14. The system as claimed in claim 13, wherein the table computer, when operating, generates a code and displays the code on one of the touch screen display and the secondary screen.

15. The system as claimed in claim 14, wherein the code is a password for entry by a user into a mobile device.

16. The system as claimed in claim 14, wherein the code is a spatial code to be read by the mobile device adjacent the code.

17. The system as claimed in claim 14, wherein the code is a time sequential code to be read by the mobile device in contact with the touch screen.

18. The system as claimed in claim 1, further comprising a video processor between the at least two mobile device connectors and the secondary screen, the video processor, when operating, superimposes content from the at least two mobile device connectors.

19. The system as claimed in claim 18, wherein, when operating, the table computer divides the secondary screen into a number screen sections to simultaneously display content from the at least two mobile device connectors.

20. The system as claimed in claim 1, wherein the table computer, when operating, divides the touch screen display into multiple sections and allows simultaneous, independent virtual keyboard entry in each section using a system keyboard.

21. A system, comprising:
a table with multiple user stations;
a touch screen embedded in a top surface of the table;
a table computer connected to the touch screen; and
a wireless network, wherein
the table computer, when operating, emulates a streaming video receiver, connects wirelessly with a mobile device, and receives content from the mobile device to be displayed on the touch screen.

22. A system, comprising:
a table with multiple user stations;
a touch screen embedded in a top surface of the table; and
a table computer connected to the touch screen, wherein, the table computer, when operating, divides the touch screen display into multiple sections and allows simultaneous, independent web browsing in each section.
